(19) United States
(12) Patent Application Publication
(10) Pub. No.: US 2024/0257206 A1
(43) Pub. Date: Aug. 1, 2024

(54) SEARCH RESULT GENERATION USING NAMED ENTITY RECOGNITION

(71) Applicant: Yext, Inc., New York, NY (US)

(72) Inventors: Alex Shaocheng Yang, Brooklyn, NY (US); Michael Misiewicz, Brooklyn, NY (US); Michael Dunn, Arlington, VA (US); Maxwell Davish, Brooklyn, NY (US); Deepak Srinivasan, Ashburn, VA (US)

(21) Appl. No.: 18/104,618

(22) Filed: Feb. 1, 2023

(51) Int. Cl. G06Q 30/0601

(52) U.S. Cl. CPC G06Q 30/0629

(57) ABSTRACT

A system and method to receive a search query including a set of search terms associated with a merchant system. A machine-learning model is executed to identify a first subset of one or more multi-term phrases associated with one or more named entity types. A set of tokens corresponding to the search query is generated, wherein the set of tokens comprises a token associated with each of the first subset of one or more multi-term phrases. A comparison of the set of tokens to a document index associated with the merchant system is executed to identify one or more matching documents. Based on the comparison, a set of search results comprising the one or more matching documents is generated.

### TECHNICAL FIELD

The present disclosure relates generally to a knowledge search platform. In particular, the present disclosure relates to identifying one or more multi-token phrases associated with multiple terms of named entities for generating search results in response to a search query.

### BACKGROUND

Many companies (e.g., merchants) employ electronic systems to provide information to consumers. For example, a web-based search system may generate and return search results in response to a search query received from an end-user system (e.g., smartphone, laptop, tablet). In this regard, the end users may use a search engine to obtain merchant-related information that is published and accessible via a network (e.g., the Internet). Search engines are software programs that search databases to collect and display information related to search terms specified by an end user.

The generation of accurate search results is important to both the end-user and the associated merchant. The efficient identification of relevant data to return as part of a search result requires searching a vast amount of indexed and searchable data. Certain search queries may include a combination of both individual search terms (e.g., a single or standalone term) and search phrases (e.g., multiple concurrent or consecutive terms that form a single concept).

It is desirable to recognize certain phrases in the search query that include a combination of multiple terms for use of those multi-term or multi-token phrases to generate more accurate search results. However, certain search systems produce search results based on the individual terms or components of what is intended by the end-user to be searched and processed as a multi-token phrase. For example, these systems may receive a query from an end-user including a phrase such as “John Smith” and undesirably return search results based on the constituent components of the search query (e.g., “John” and “Smith”), such as “John Doe” and “Adam Smith”.

### BRIEF DESCRIPTION OF THE FIGURES

The present disclosure will be understood more fully from the detailed description given below and from the accompanying drawings of various implementations of the disclosure.

FIG. 1 illustrates an example environment that includes a search management system including a named entity phrase manager, according to embodiments of the present disclosure.

FIG. 2 illustrates an example process flow relating to generating search results including matches associated with one or more named entity recognition phrases, according to embodiments of the present disclosure.

FIG. 3 illustrates an example search management system to identify examples of matching phrases for inclusion in a set of search results and examples of non-matching phrases to be excluded from the set of search results, according to embodiments of the present disclosure.

FIG. 4 is an example flow diagram including a search result generation process executed by a search management system based on named entity recognition phrases, according to embodiments of the present disclosure.

FIG. 5 is a block diagram of an example computer system in which implementations of the present disclosure can operate.

### DETAILED DESCRIPTION

Aspects of the present disclosure address and overcome the aforementioned problems associated with certain search management systems by implementing methods and systems to execute a machine-learning model to identify multi-token phrases in a search query. According to embodiments, the system (herein a “search management system”) processes a search query received from an end-user system. The search management system identifies one or more multi-token phrases associated with one or more named entity types.

According to embodiments, the search management system implements a machine-learning model trained to recognize multi-term phrases corresponding to one or more named entity types (herein referred to as a “named entity recognition model” or “NER model”). Example named entity types include a person, a location, an event, a product, a procedure, a condition, a specialty, etc. According to embodiments, the NER phrase query processing enables retrieval of search results based on the presence of entire phrases or multi-term sequences that are evaluated as a single unit. The evaluation is performed to determine if a document including the identified NER phrase is to be included in the search results returned to an end-user system in response to a search query.

For a given search query, the NER model is executed to identify one or more NER phrases within the search query. The NER phrases are processed and maintained as a single combination of two or more terms. According to embodiments, an identified NER phrase can be used to search a document index maintained by the search management system to generate a search result to return to the end-user system.

In an embodiment, the search management system identifies certain named entities as phrases, such that individual terms or components of the NER phrase are excluded (i.e., not returned) as part of the search result. In an embodiment, in response to receipt of the search query originated by an end-user system, the search management system tags one or more portions of the search query as a named entity phrase associated with a named entity type. Advantageously, the tagged named entity is subsequently identified as a phrase when searching the document index during generation of the search result. Accordingly, the generated search results are based on the entire NER phrase, instead of portion of the identified NER phrase. Advantageously, two or more terms of a search query can be recognized as associated with a named entity type and processed as a multi-token phrase for purposes of generating search results. According to embodiments, the NER model detects and identifies sequences of tokens that apply to a single entity.

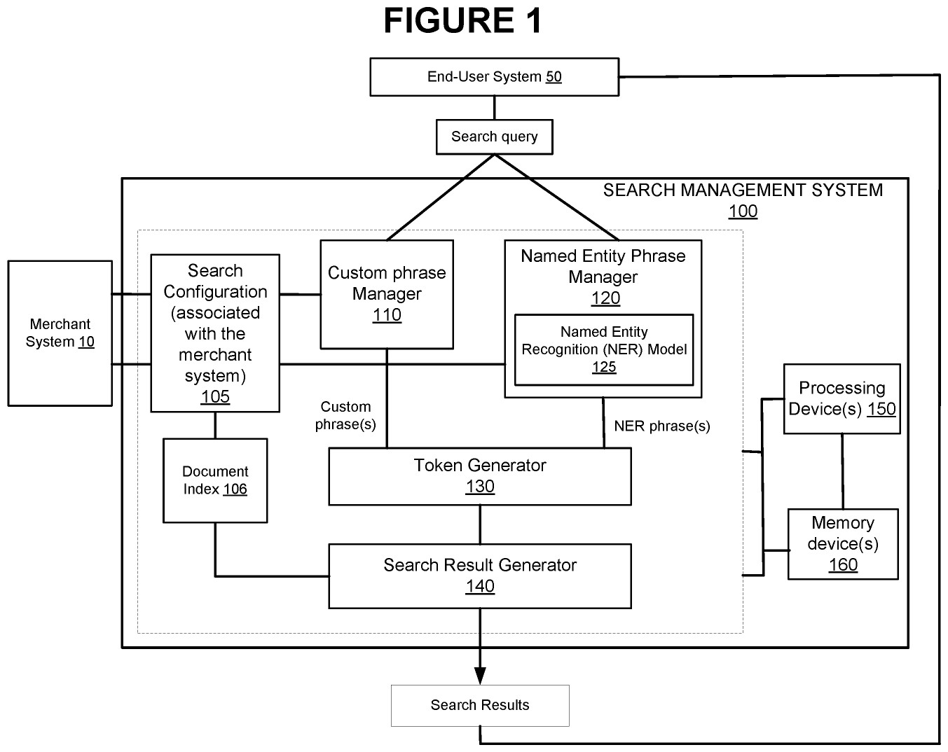

FIG. 1 illustrates an example computing environment including a search management system 100 operatively coupled to one or more merchant systems 10 and one or more end-user systems 50. In one embodiment, the search management system 100 enables an end-user operating a communicatively connected end-user system 50 to submit a search query. In an embodiment, the search query can include a set of search terms relating to a merchant. In an embodiment, the search management system 100 processes the search query and generates search results to be returned to the end-user system 50. According to embodiments, the search management system 100 identifies one or more multi-token phrases (e.g., a combination of multiple tokenized terms) relating to one or more named entity types (herein referred to as “named entity phrases” or “NER phrases”).

According to embodiments, the search management system 100 includes modules configured to perform various functions, operations, actions, and activities, as described in detail herein. In an embodiment, the search management system 100 includes a search configuration 105 including a document index 106, a custom phrase manager 110, a named entity phrase manager 120, a token generator 130, and a search result generator 140. In an embodiment, the named entity phrase manager 120 includes a named entity recognition (NER) model 125 (i.e., a machine-learning model) configured to process search queries and identify or multi-term phrases associated with one or more named entity types (e.g., a person type, a location type, an event type, a procedure type, a condition type, a specialty type, a brand type, a product type, etc.). According to embodiments, the one or more multi-term phrases identified by the NER model 125 are used by the search result generator 140 in generating the search results provided in response to the search query.

In an embodiment, the search management system 100 is operatively coupled to one or more merchant systems 10 and one or more end-user systems 50 via a suitable network (not shown). Examples of such a network include the Internet, intranets, extranets, wide area networks (WANs), local area networks (LANs), wired networks, wireless networks, other suitable networks, or any combination of two or more such networks. In one embodiment, the search management system 100 includes the processing device 150 and a memory 160 configured to execute and store instructions associated with the functionality of the various components, services, and modules of the search management system 100, as described in greater detail below in connection with FIGS. 1-5.

According to embodiments, the search management system 100 may be part of a third-party system (e.g., a search engine provider), a merchant system 10, or established as a stand-alone or separate search system. In an embodiment, the search management system 100 receives a search query from an end-user system 50, where the search query relates to a merchant associated with the merchant system 10. In an embodiment, the search query is provided to the custom phrase manager 110. The custom phrase manager 110 is configured to maintain a set of custom phrases associated with a merchant system (e.g., merchant system 10). In an embodiment, the merchant system 10 can submit one or more custom phrases for storing in a search configuration 105 storing data associated with the merchant. In an embodiment, the search configuration 105 is a file (e.g., a JSON object) storing properties relating to how one or more search types associated with the merchant system 10 are to be implemented and handled. For example, the search configuration 105 can include multiple files, where each file includes search properties (e.g., rules, parameters, etc.) associated with a particular search type or experience associated with the merchant system 10. In an embodiment, the search configuration 105 associated with the merchant system 10 can operatively couple to a document index 106 including a set of documents associated with the merchant. The set of documents in the document index 106 can be searched by the search result generator 140 to identify the one or more documents to include in the search results to be returned to the end-user system 50.

In an embodiment, each custom phrase of the set of custom phrases can include a combination of two or more terms. In an embodiment, the custom phrase manager 110 reviews the search query and identifies and tags a set of one or more custom phrases in the search query. In an embodiment, the search configuration 105 includes the set of custom phrases associated with the merchant system 10 which is used by the custom phrase manager 110 in reviewing the search query. In an embodiment, the custom phrase manager 110 compares the search query to the custom phrases maintained in the search configuration 105 to identify the one or more custom phrases in the search query. According to embodiments, the maintenance and identification of custom phrases can be optional (i.e., a set of custom phrases may not be maintained for a particular merchant system). In such embodiments, the functionality associated with the custom phrase manager 110 may be disabled in the search management system 100.

In an embodiment, the named entity phrase manager 120 receives the search query and executes the NER model 125 to identify a set of one or more NER phrases in the search query. In an embodiment, the NER model 125 is trained to identify NER phrases associated with a taxonomy of NER types. The NER model 125 enables information extraction and seeks to locate and classify named entities mentioned in unstructured text into one or more pre-defined categories (i.e., NER types), such as person names, organizations, locations, events, procedures, conditions, specialties, products, brands, institutions, etc. For example, the NER model 125 may be configured to detect “John Doe” as an NER phrase (i.e., multi-term phrase) associated with a “person” NER type. In an embodiment, each identified NER phrase is managed as a single entity (i.e., a combination of multiple terms that are treated as a single multi-term phrase for purposes of evaluating matches in a document index).

In an embodiment, the merchant system 10 can submit one or more selections to the search management system 100 (e.g., via a graphical user interface associated with the search management system 100) of one or more NER types for use by the NER model 125 of the named entity phrase manager 120 in automatically identifying multi-term NER phrases. In an embodiment, one or more NER phrases identified by the named entity phrase manager 120 can be provisioned to the merchant system 10 for feedback relating to the identified NER phrases. In an embodiment, the merchant system 10 can provide indications to the named entity phrase manager 120 to “approve”, “reject”, or “modify” one or more of the NER phrases identified by the NER model 125.

According to embodiments, the set of one or more NER phrases identified in the search query by the named entity phrase manager 120 are provided to the token generator 130. In an embodiment, the set of one or more custom phrases identified by the custom phrase manager 110 are provided to the token generator 130. In embodiments, the token generator 130 generates a set of tokens corresponding to the individual terms and NER phrases associated with the search query. In an embodiment, if enabled, the identified custom phrases are tokenized by the token generator 130.

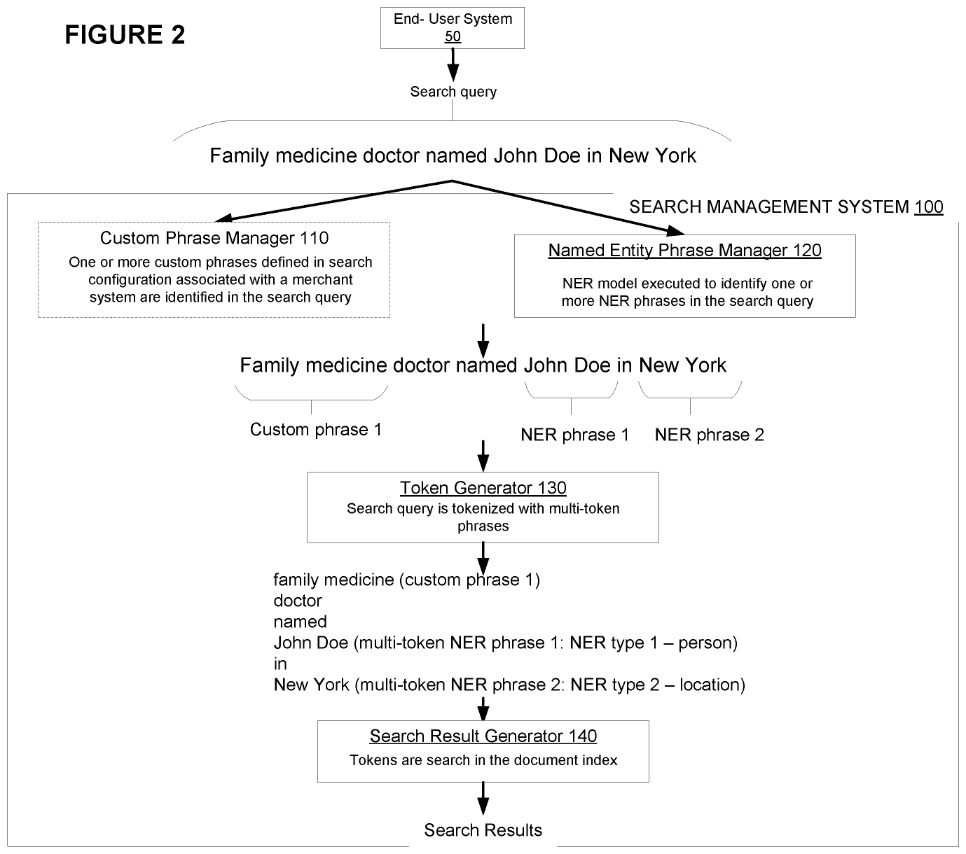

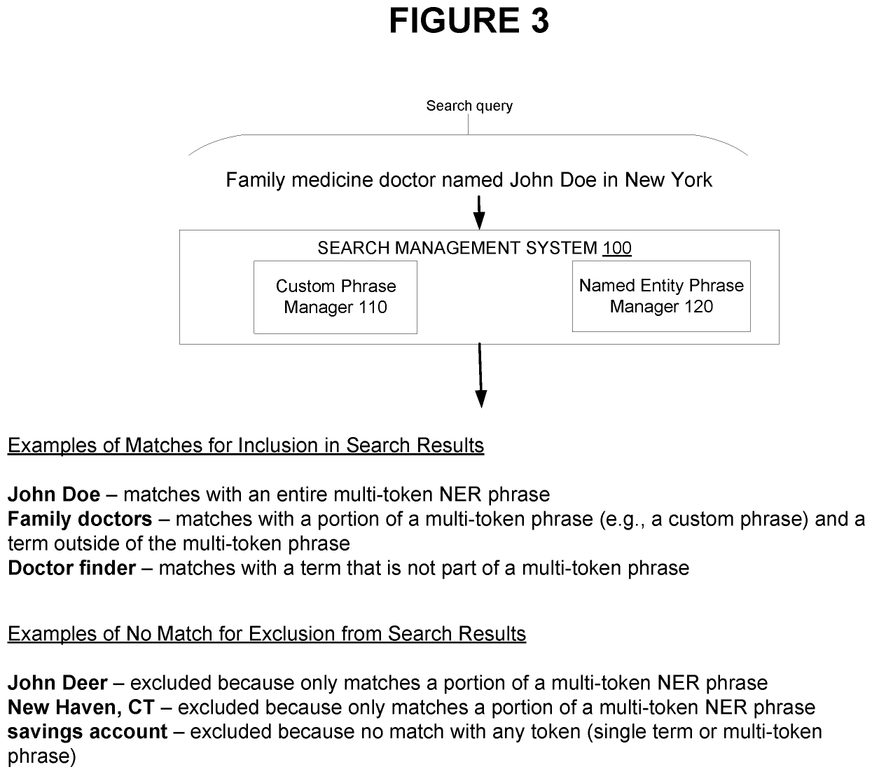

According to embodiments, tokenizing the multi-term NER phrase transforms the multiple individual terms into a single combination of the multiple terms of the NER phrase. For example, the tokens are generated that represent an NER phrase of “John Doe”, such that the entire multi-token NER phrase is considered for purposes of generating search results corresponding to the search query. Examples of multi-token NER phrase generation and processing to produce search results are described in greater detail with respect to FIGS. 2 and 3.

According to embodiments, the tokens associated with the search query (e.g., tokens associated with single terms and multi-token phrases) generated by the token generator are provided to the search result generator 140. The search result generator 140 compares the generated tokens with the document index 106. In an embodiment, the search result generator 140 searches the document index 106 using the set of tokens including the subset of tokens associated with single terms and the subset of multi-token NER phrases. In an embodiment, one or more multi-token custom phrases identified by the custom phrase manager 110 and processed by the token generator 140 are provided to the search result generator 140 for use in searching the document index 106.

In an embodiment, based on a comparison of the set of tokens (set of single-term tokens and multi-token NER phrases) and the data in the document index 106, the search result generator 140 generates a set of search results. In an embodiment, the set of search results can be provisioned by the search management system 100 to the end-user system 50 (e.g., via an interface of a search engine platform, a website or application associated with the merchant system 10, etc.).

FIG. 2 illustrates a method of processing a search query by a search management system (e.g., search management system 100 of FIG. 1) including NER phrase identification to generate associated search results, according to embodiments of the present disclosure. As shown in the example of FIG. 2, an end-user system 50 submits a search query to a search management system 100. In this example, the search query is “Family medicine doctor named John Doe in New York”.

In an embodiment, a named entity phrase manager 120 executes an NER model to identify one or more NER phrases in the search query. In an embodiment, the set of one or more NER phrases can be determined by executing the NER model based on one or more defined NER types. In an embodiment, the NER types can be identified by a merchant system for use in generating search results based on the merchant system's data. Example NER types include, but are not limited to a person type, a location type, an event type, a procedure type, a specialty type, a condition type, a brand type, a product type, etc.

In this example, the named entity phrase manager 120 is trained to identify NER phrases associated with at least the following example named entity types: person type and location type. Applying the NER model to the example search query, the named entity phrase manager 120 identifies “John Doe” as a first NER phrase and “New York” as a second NER phrase. In this example, the custom phrase functionality is enabled and identifies “family medicine” as a first custom phrase.

As illustrated, the search query with the identified NER phrases (“John Doe” and “New York”) is provided to the token generator 130. In this example, the custom phrase (“Family medicine”) is also provided to the token generator 130. The token generator 130 generates tokens for the following terms and phrases: “family medicine” (a first multi-token custom phrase), “doctor”, “named”, “John Doe” (a first multi-token NER phrase), “in”, and “New York” (a second multi-token NER phrase). As illustrated, advantageously, the identified NER phrases are tokenized as a multi-token phrase that includes multiple terms that are treated as an ordered combination.

In an embodiment, the search query is tokenized with multi-token phrases maintained as multi-term or multi-token phrases. The tokenized search query is provided to the search result generator 140 for use in searching the document index (e.g., a document index stored in a knowledge graph). In an embodiment, each of the above-identified tokens and phrases are search in the document index to identify a set of search results (e.g., one or more identified documents that meet suitability criteria for inclusion in the search results provided to the end-user system 50).

According to embodiments, the search results include data or documents that contain the one or more NER phrases in their respective entireties, with all of the tokens of the multi-token NER phrase in the same order as the phrase as it is in the search query. In embodiments, the search management system identifies and retrieves documents from a database of documents that include an entire NER phrase (and/or custom phrase) according to one or more rules. In an embodiment, one or more rules can be applied, such as: 1) all terms in an NER phrase (and/or custom phrase) must appear in a document for the document to be included in the search results; 2) the terms of the NER phrase (and/or custom phrase) must appear in a document in the same order as the identified NER phrase (and/or custom phrase) to be included in the search results; or 3) the terms of the NER phrase must appear consecutively and in the same order as the identified NER phrase (and/or custom phrase) for the document to be included in the search results. According to embodiments, the rules are configurable by a merchant system, such that the merchant system can indicate which rule or combination of rules to be applied in retrieving documents from a document index in a knowledge graph to be returned as part of the search results returned to an end-user system.

In the example shown in FIG. 2, a document including the phrase “John Smith Doe” is not a match to the identified “John Doe” NER phrase and is excluded from the search results. In the example shown in FIG. 3, a document including the phrase “John Doe Smith” is a match to the identified “John Doe” NER phrase (i.e., in view of having the same order of tokens) and can be included in the search results.

In another example (not shown in FIG. 2), the search management system 100 may identify “John Doe Smith” as a multi-token NER phrase. In this case, neither “John Doe” nor “John Smith” match the identified NER phrase because they represent only partial matches with the identified NER phrase. In an embodiment, a rule can be established and implemented by the search management system 100 such that a match can be identified for the term “John Smith Doe” and the multi-token NER phrase “John Doe”. In this configuration, the rule can allow for matches including two or more terms in the NER phrase, even if the order is not the same.

In an embodiment, a result is considered a match if there is a match between any token in the query that is not part of an identified phrase. For example, the phrase “family doctors” is returned as a match, because “doctors” is a single-term token in the query that separately matches with “family doctors”. In this example, “Doctor Doe” or “Doctors Doe” would be matches because the result matches with another token in the query.

FIG. 3 illustrates examples of matching search results and non-matching terms and phrases relating to a search query processed by a search management system 100 including a custom phrase manger 110 and a named entity phrase manager 120. As shown in FIG. 3, the example search query is “Family medicine doctor named John Doe in New York”. Following processing of the custom phrase manager 110 and named entity phrase manager 120, a first custom phrase is identified (“family doctors”), a first NER phrase is identified (“John Doe”), and a second NER phrase is identified (“New York”). According to embodiments, in this example, the matching examples are included in the search results.

FIG. 3 further illustrates some examples of non-matching data that is to be excluded from the generated search results. Illustrative examples include, but are not limited to, “John Deer” (excluded because the terms of the phrase only match a portion of a multi-token NER phrase), “New Haven, CT” (excluded because the terms of the phrase only match a portion of a multi-token NER phrase), and “savings account” (excluded because the terms of the phrase do not match any identified token (single token or multi-token phrase).

According to embodiments, examples of matches for inclusion in the search results corresponding to the example search query include, but are not limited to: “John Doe” (matches an entire multi-token NER phrase; “Family doctors” (matches with a portion of a multi-token phrase (i.e., the first custom phrase) and a term matching a single-term token (e.g., “doctor) that is outside of the multi-token phrase; and “doctor finder” (matches with a token that is not part of a multi-token phrase).

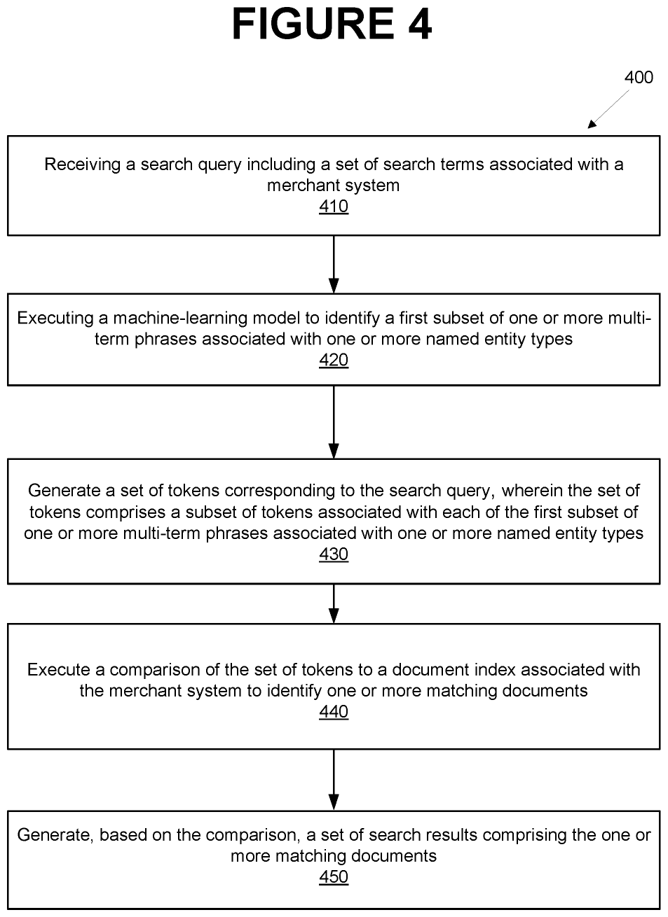

FIG. 4 illustrates a flow diagram illustrating an example process 400 including steps performed by a search management system (e.g., search management system 100 of FIGS. 1-3) to generate search results including identified NER phrases for an end-user system in response to a search query, according to embodiments of the present disclosure. The process 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In operation 410, the processing logic (e.g., processing logic of the search management system 100 of FIGS. 1-3) receives a search query including a set of search terms associated with a merchant system. In an embodiment, the search query is received from an end-user system operatively coupled to the processing logic. In embodiments, the processing logic of the search management system can be part of a merchant system (e.g., a website or application associated with a merchant, a search engine platform, or a standalone system). In an embodiment, the search query includes terms submitted to retrieve search results including relevant information associated with the merchant system.

According to embodiments, the processing logic can also identify a second subset of custom phrases included in the search query. A custom phrase is a preset sequence of multiple terms that are predefined for recognition in a search query. According to embodiments, a merchant system can submit one or more custom phrases to be identified.

In operation 420, the processing logic executes a machine-learning model to identify a first subset of one or more multi-term phrases associated with one or more named entity types. In an embodiment, the machine-learning model is a named entity recognition (NER) model configured to identify a sequence of two or more terms in the search query as a NER phrase. The one or more identified NER phrases are associated with a named entity type (e.g., a person type, a location type, a condition type, a brand type, a product type, etc.). For example, the one or more NER phrases identified by the trained machine-learning model (i.e., the NER model) can include a multiple sequence of terms, such as “John Doe”, “New York City”, “mortgage rate”, etc.

In operation 430, the processing logic generates a set of tokens corresponding to the search query, wherein the set of tokens comprises a subset of tokens associated with each of the one or more multi-term phrases associated with one or more named entity types (i.e., NER phrases). In an embodiment, the processing logic identifies a first subset of tokens (e.g., two or more tokens) associated with a first multi-token phrase (e.g., a first identified NER phrase), a second subset of tokens (e.g., two or more tokens) associated with a second multi-token phrase (e.g., a second identified NER phrase), and so on. Accordingly, each multi-token phrase is managed as a single combination of two or more terms during subsequent processing.

In operation 440, the processing logic executes a comparison of the set of tokens to a document index associated with the merchant system to identify one or more matching documents. In an embodiment, the comparison is executed to identify one or more documents in the document index that include the one or more multi-term phrases. For example, the processing logic searches the document index for documents that match with the entire phrase (e.g., the ordered sequence of multiple terms of the NER phrase or custom phrase) and/or any other non-stopword terms in the search query (e.g., using tokens associated with single terms (e.g., non-NER phrases and non-custom phrases) in the search query. In an embodiment, the comparison is executed to identify matches of the entire NER phrase or custom phrase in the one or more documents of the document index.

In an embodiment, the one or more matching documents are identified using a suitable searching algorithm. The processing logic can apply one or more search rules to identify phrase matches (e.g., matches between data in a document and one or more identified NER phrases and/or custom phrases). For example, a rule may be applied that indicates if a field of a document is searched using phrase matching, a match is identified if the field value includes the entirety of an NER phrase and/or custom phrase. In an embodiment, the one or more search rules can include a rule indicating that if a field is searched with a natural language processing filter, the filter is applied if the field value includes the entirety of an NER phrase and/or custom phrase.

In operation 450, the processing logic generating, based on the comparison, a set of search results comprising the one or more matching documents. In an embodiment, the search results corresponding to a search query can be generated, determined or identified using a search engine executing a search algorithm configured to identify the one or more matches corresponding to the identified phrases (e.g., one or more NER phrases and one or more custom phrases). The search algorithm can include a set of computer-implementable instructions executed to retrieve information (e.g., documents) stored in a document index for provisioning search results in response to a search query. In an embodiment, a search algorithm can have many different parts or components that enable the execution of a search as part of a search experience corresponding to an end-user system (e.g., a system associated with an end user submitting a search query) and a merchant (e.g., a company or entity for which the end-user system is seeking information in accordance with the search query). For example, the search algorithm can include components such a spell check component configured to generate an accurate spelling correction associated with a search query, a natural language processing (NLP) filtering component configured to infer or identify a correct NLP filter for search results based on processing of the meaning and context of one or more words or phrases of a search query, and a direct response or “direct answers” component configured to provide a direct response to a search query.

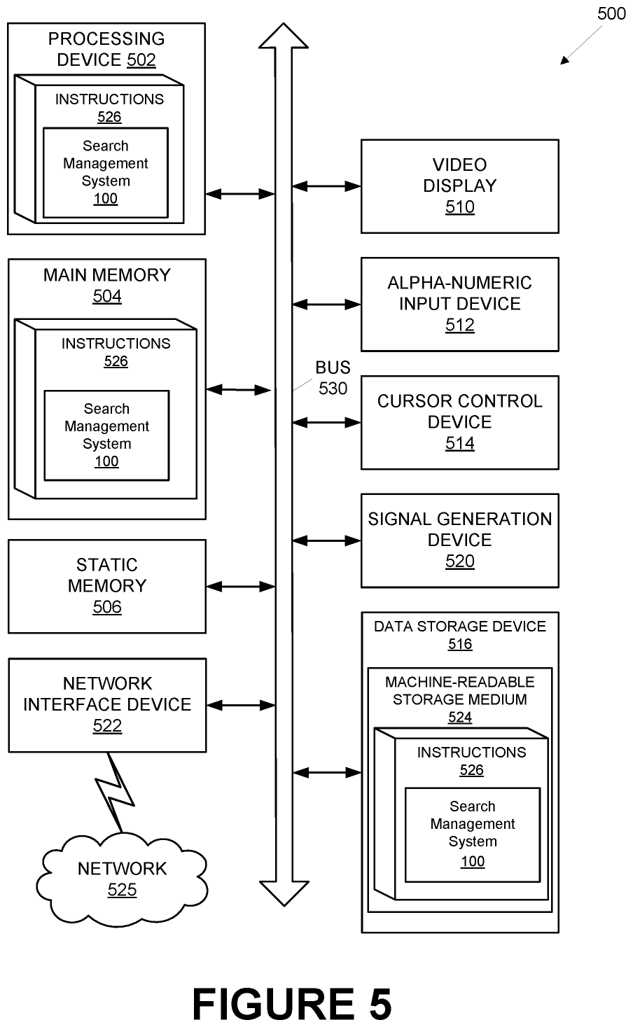

FIG. 5 illustrates an example computer system 500 operating in accordance with some embodiments of the disclosure. In FIG. 5, a diagrammatic representation of a machine is shown in the exemplary form of the computer system 500 within which a set of instructions, for causing the machine to perform any one or more of the methodologies discussed herein, may be executed. In alternative embodiments, the machine 500 may be connected (e.g., networked) to other machines in a local area network (LAN), an intranet, an extranet, or the Internet. The machine 500 may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine 500. Further, while only a single machine is illustrated, the term “machine” shall also be taken to include any collection of machines that individually or jointly execute a set (or multiple sets) of instructions to perform any one or more of the methodologies discussed herein.

The example computer system 500 may comprise a processing device 502 (also referred to as a processor or CPU), a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 516), which may communicate with each other via a bus 530.

Processing device 502 represents one or more general-purpose processing devices such as a microprocessor, central processing unit, or the like. More particularly, the processing device may be a complex instruction set computer (CISC) processor, reduced instruction set computer (RISC) processor, very long instruction word (VLIW) processor, or processor implementing other instruction sets, or processors implementing a combination of instruction sets. Processing device 502 may also be one or more special-purpose processing devices such as a graphics processing unit (GPU), an application specific integrated circuit (ASIC), a field programmable gate array (FPGA), a digital signal processor (DSP), network processor, or the like. Processing device 502 is configured to execute the search management system 100 performing the operations and steps discussed herein. For example, the processing device 502 may be configured to execute instructions implementing the processes and methods described herein, for supporting a search management system 100, in accordance with one or more aspects of the disclosure.

Example computer system 500 may further comprise a network interface device 522 that may be communicatively coupled to a network 525. Example computer system 500 may further comprise a video display 510 (e.g., a liquid crystal display (LCD), a touch screen, or a cathode ray tube (CRT)), an alphanumeric input device 512 (e.g., a keyboard), a cursor control device 514 (e.g., a mouse), and an acoustic signal generation device 520 (e.g., a speaker).

Data storage device 516 may include a computer-readable storage medium (or more specifically a non-transitory computer-readable storage medium) 524 on which is stored one or more sets of executable instructions 526. In accordance with one or more aspects of the disclosure, executable instructions 526 may encode various functions of the search management system 100 in accordance with one or more aspects of the disclosure.

Executable instructions 526 may also reside, completely or at least partially, within main memory 504 and/or within processing device 502 during execution thereof by example computer system 500. Main memory 504 and processing device 502 also constitute computer-readable storage media. Executable instructions 526 may further be transmitted or received over a network via network interface device 522.

While computer-readable storage medium 524 is shown as a single medium, the term “computer-readable storage medium” should be taken to include a single medium or multiple media. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “analyzing,” “using,” “receiving,” “presenting,” “generating,” “deriving,” “providing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Examples of the disclosure also relate to an apparatus for performing the methods described herein. This apparatus may be specially constructed for the required purposes, or it may be a general-purpose computer system selectively programmed by a computer program stored in the computer system. Such a computer program may be stored in a computer readable storage medium, such as, but not limited to, any type of disk (including optical disks, compact disc read-only memory (CD-ROMs), and magnetic-optical disks, read-only memories (ROMs), random access memories (RAMs), EPROMs, EEPROMs, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the scope of the disclosure is not limited to any particular programming language. It will be appreciated that a variety of programming languages may be used to implement the teachings of the disclosure.

It is to be understood that the above description is intended to be illustrative, and not restrictive. Many other embodiment examples will be apparent to those of skill in the art upon reading and understanding the above description. Although the disclosure describes specific examples, it will be recognized that the systems and methods of the disclosure are not limited to the examples described herein, but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A method comprising:
receiving a search query including a set of search terms associated with a merchant system;
executing, by a processing device, a machine-learning model to identify a first subset of one or more multi-term phrases associated with one or more named entity types;
generating a set of tokens corresponding to the search query, wherein the set of tokens comprises a subset of tokens associated with each of the one or more multi-term phrases associated with the one or more named entity types;
executing a comparison of the set of tokens to a document index associated with the merchant system to identify one or more matching documents; and
generating, based on the comparison, a set of search results comprising the one or more matching documents.

2. The method of claim 1, wherein the machine-learning model comprises a named entity recognition (NER) model.

3. The method of claim 1, wherein the first subset of one or more multi-term phrases comprise one or more NER phrases.

4. The method of claim 3, further comprising identifying a second subset of one or more multi-term phrases comprising one or more custom phrases, wherein the one or more custom phrases are defined by the merchant system.

5. The method of claim 1, wherein the one or more matching documents include a sequence of terms matching an ordered sequence of a first multi-term phrase of the one or more multi-term phrases.

6. The method of claim 1, further comprising receiving one or more selections of the one or more named entity types identifiable by the machine-learning model.

7. The method of claim 1, wherein the one or more matching documents include a sequence of terms matching at least a portion of a first multi-term phrase of the one or more multi-term phrases and another term associated with a token of the search query.

8. A system comprising:
a memory to store instructions; and
a processing device operatively coupled to the memory, the processing device to execute the instructions to perform operations comprising:
receiving a search query including a set of search terms associated with a merchant system;
executing, by a processing device, a machine-learning model to identify a first subset of one or more multi-term phrases associated with one or more named entity types;
generating a set of tokens corresponding to the search query, wherein the set of tokens comprises a subset of tokens associated with each of the one or more multi-term phrases associated with the one or more named entity types;
executing a comparison of the set of tokens to a document index associated with the merchant system to identify one or more matching documents; and
generating, based on the comparison, a set of search results comprising the one or more matching documents.

9. The system of claim 8, wherein the machine-learning model comprises a named entity recognition (NER) model.

10. The system of claim 8, wherein the first subset of one or more multi-term phrases comprise one or more NER phrases.

11. The system of claim 10, the operations further comprising identifying a second subset of one or more multi-term phrases comprising one or more custom phrases, wherein the one or more custom phrases are defined by the merchant system.

12. The system of claim 8, wherein the one or more matching documents include a sequence of terms matching an ordered sequence of a first multi-term phrase of the one or more multi-term phrases.

13. The system of claim 8, the operations further comprising receiving one or more selections of the one or more named entity types identifiable by the machine-learning model.

14. The system of claim 8, wherein the one or more matching documents include a sequence of terms matching at least a portion of a first multi-term phrase of the one or more multi-term phrases and another term associated with a token of the search query.

15. A non-transitory computer readable storage medium having instructions that, if executed by a processing device, cause the processing device to perform operations comprising:
receiving a search query including a set of search terms associated with a merchant system;
executing, by a processing device, a machine-learning model to identify a first subset of one or more multi-term phrases associated with one or more named entity types;
generating a set of tokens corresponding to the search query, wherein the set of tokens comprises a subset of tokens associated with each of the one or more multi-term phrases associated with the one or more named entity types;
executing a comparison of the set of tokens to a document index associated with the merchant system to identify one or more matching documents; and
generating, based on the comparison, a set of search results comprising the one or more matching documents.

16. The non-transitory computer readable storage medium of claim 15, wherein the machine-learning model comprises a named entity recognition (NER) model.

17. The non-transitory computer readable storage medium of claim 15, wherein the first subset of one or more multi-term phrases comprise one or more NER phrases.

18. The non-transitory computer readable storage medium of claim 17, the operations further comprising identifying a second subset of one or more multi-term phrases comprising one or more custom phrases, wherein the one or more custom phrases are defined by the merchant system.

19. The non-transitory computer readable storage medium of claim 15, wherein the one or more matching documents include a sequence of terms matching an ordered sequence of a first multi-term phrase of the one or more multi-term phrases.

20. The non-transitory computer readable storage medium of claim 19, the operations further comprising receiving one or more selections of the one or more named entity types identifiable by the machine-learning model.
